(19) United States
(12) Patent Application Publication
(10) Pub. No.: US 2013/0268438 A1
(43) Pub. Date: Oct. 10, 2013

(54) Virtual Currency Payment Network

(71) Applicant: MONETARIS, LLC, Montclair, NJ (US)

(72) Inventor: Edward Boyle, Montclair, NJ (US)

(73) Assignee: MONETARIS, LLC, Montclair, NJ (US)

(21) Appl. No.: 13/630,557

(22) Filed: Sep. 28, 2012

Related U.S. Application Data
(60) Provisional application No. 61/540,761, filed on Sep. 29, 2011.

(51) Int. Cl. G06Q 20/38

(52) U.S. Cl. CPC G06Q 20/381
USPC 705/44

(57) ABSTRACT

A method and system for making purchase payment transactions with merchants, using virtual (eg: points-based) currencies issued by parties other than that of the merchant. Specifically, this invention is a payment network that processes payment instructions across multiple merchants, the payments being made with virtual currency (ie: private, non-sovereign currency, such as loyalty points and social network credits) issued by multiple virtual currency programs (eg: as those from airline, hotel, credit card, social media and gaming companies).

### CROSS REFERENCE TO RELATED APPLICATIONS

This application claims the benefit of U.S. Provisional Application No. 61/540,761, filed Sep. 29, 2011.

### TECHNICAL FIELD OF THE INVENTION

The invention generally relates to ecommerce and, in particular, to a system and method in which an issuer of virtual currency permits its customers to transact a purchase from a merchant using the virtual currency rather than sovereign currency.

### BACKGROUND OF THE INVENTION

Various entities issue virtual currencies as part of their business, such as loyalty programs (eg: frequent flier programs, credit card loyalty reward programs), awards (eg: points earned via online video gaming), and private currencies (eg: social network credits). Such virtual currencies are highly restricted in their usability. For example, Facebook Credits are usable only via Facebook.com, BestBuy RewardZone points are redeemable only at BestBuy and frequent flier miles are usually reserved for airline seats with the associated airline. And, whereas many currencies, such as credit card reward points, are typically redeemable for travel, merchandise and gift cards, most all programs require the consumer to redeem their points via the program's Website, due largely to technical limitations. A few programs have deployed proprietary solutions that enable consumers to redeem points directly at select merchant partners but they require the consumer to register their points program account at the merchant and require the merchant to significantly customize their checkout systems to link to the individual points program or programs. In some instances, the consumer's card account is first debited to conduct a real-money transaction with the merchant before being credited in an equal amount by the loyalty program after it processes a debit of a commensurate amount of points from the associated loyalty account. Last, some third-party solution providers aggregate loyalty points from a plurality of programs into a single exchange account associated with the user, thereby establishing a stored-value account used for processing transactions.

While some issuers of virtual currencies see value in enabling incremental redemption opportunities, some would see negative value in enabling their currencies to be aggregated with those of other programs.

As Mastercard and VISA have done with real-money payment processing, there is an opportunity to connect multiple merchants to a network system that connects to multiple virtual currency programs, without requiring consumer registration or pairing or linking of their accounts to merchants, and not using shadow transactional accounts and not aggregating points or credits from multiple programs in an exchange account.

### SUMMARY OF THE INVENTION

The invention addresses the above needs as well as others by providing a method and system that enables virtual currency programs to permit their program participants to transact purchases with merchants using the virtual currency alone, or a combination of virtual currency and real money, without requiring the participant to create an intermediary account or the system to utilize a shadow transaction account. The invention particularly addresses the needs for a loyalty program to permit a loyalty program participant to make ecommerce purchases directly from a merchant Web site by providing a system and method which handles secure messaging, authentication, authorization and settlement between the parties without need for a point of sale device, a shadow transaction account or user exchange account.

The invention enables the virtual currency issuer to reduce their outstanding virtual currency supply; further, it enables merchants to sell more goods and services and it also enables consumers to get more use and satisfaction from the virtual currency.

In one embodiment, the invention comprises a system that enables a merchant to offer a participant of a points-based loyalty reward program the option of paying for their purchase with their program points. The system is able to gather information from the user to authenticate the user as a participant in the relevant points program and is further able to determine the amount of points available to the user. Further, the system is able to calculate multiple redemption amounts using multiple redemption rates. The system enables the user to authorize the points program to debit the points from the user's points account and the system processes settlement instructions for the points issuer and transaction authorization information for the merchant. The system is able to support a similar process for transaction cancellations, refunds and reconciliations.

Other embodiments would include but not necessarily be limited to the below:

Use of a browser extension to effect the transaction by generating a code (eg: coupon code) specific to any given participating merchant

Use of a computer application to effect the transaction by generating a code (eg: coupon code) specific to any given participating merchant

Use of a smartphone application to effect the transaction by generating a code (eg: coupon code) specific to any given participating merchant

Use of a browser extension to effect the transaction by generating a one-time use and/or encrypted code (eg: payment network unique ID) that would likely work at the given merchant, regardless of whether the merchant had agreed to participate in the system

Use of a computer application to effect the transaction by generating a one-time use and/or encrypted code (eg: payment network unique ID) that would likely work at the given merchant, regardless of whether the merchant had agreed to participate in the system

Use of a smartphone application to effect the transaction by generating a one-time use and/or encrypted code (eg: payment network unique ID) that would likely work at the given merchant, regardless of whether the merchant had agreed to participate in the system

Use of a transaction card (eg: magstripe, chip, barcode, etc enabled) that would route through traditional payment card networks (eg: Mastercard, VISA, Discover) and default to debiting one or more loyalty programs

Use of a transaction card (eg: magstripe, chip, barcode, etc enabled) that would route through a non-traditional payment networks (eg: the merchant's POS system, a stored-value card processing system, the Internet, etc.) and default to debiting one or more loyalty programs

### BRIEF DESCRIPTION OF THE DRAWINGS

FIG. 1 is a high-level block diagram of the system.

FIG. 2 is a block diagram of the major system components.

FIG. 3 is a flow-diagram of the method for a purchase utilizing payment integration with the merchant.

FIG. 4. Is a flow-diagram of the method for a purchase utilizing a merchant-specific code.

FIG. 5. Is a flow-diagram of the method for a purchase utilizing a unique identifier provided by a payment network.

FIG. 6. Is a flow-diagram of the method for processing settlement.

FIG. 7. Is a flow-diagram of the method for processing a refund.

FIG. 8. Is a flow diagram of the method for processing a chargeback.

FIG. 9. Is a flow diagram of the method for processing reconciliations.

### DETAILED DESCRIPTION OF THE INVENTION

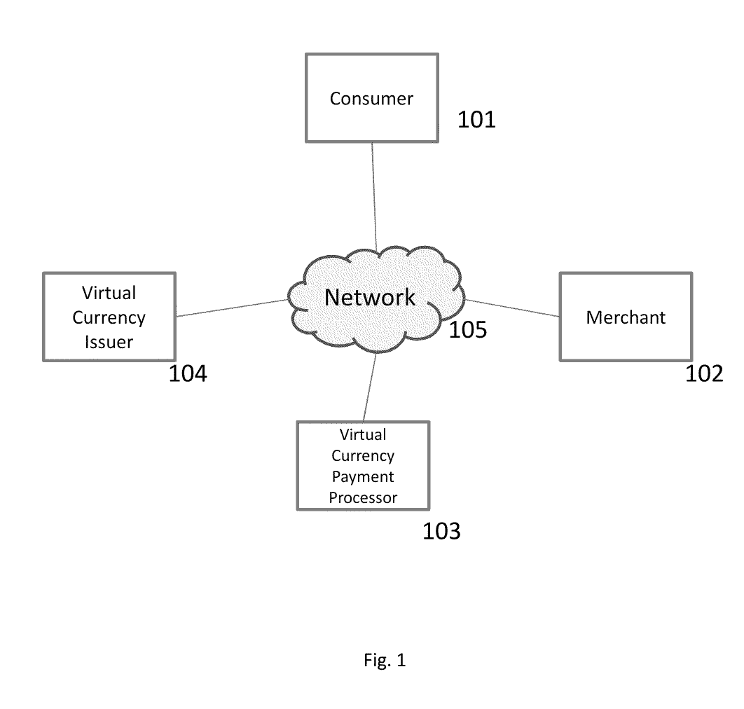

The present invention is a computer-implemented apparatus, system and method for making payment transactions using virtual currencies issued by parties other than that of the party accepting the payment. Specifically, and in summary of FIG. 1, this invention is a virtual currency payment system that uses computer networks 105 and a payment processor 103 and processes payment instructions on behalf of consumers 101 and merchants 102, the payments being made with virtual currencies from virtual currency programs 104, such as those from airline, hotel, credit card, social media and gaming companies.

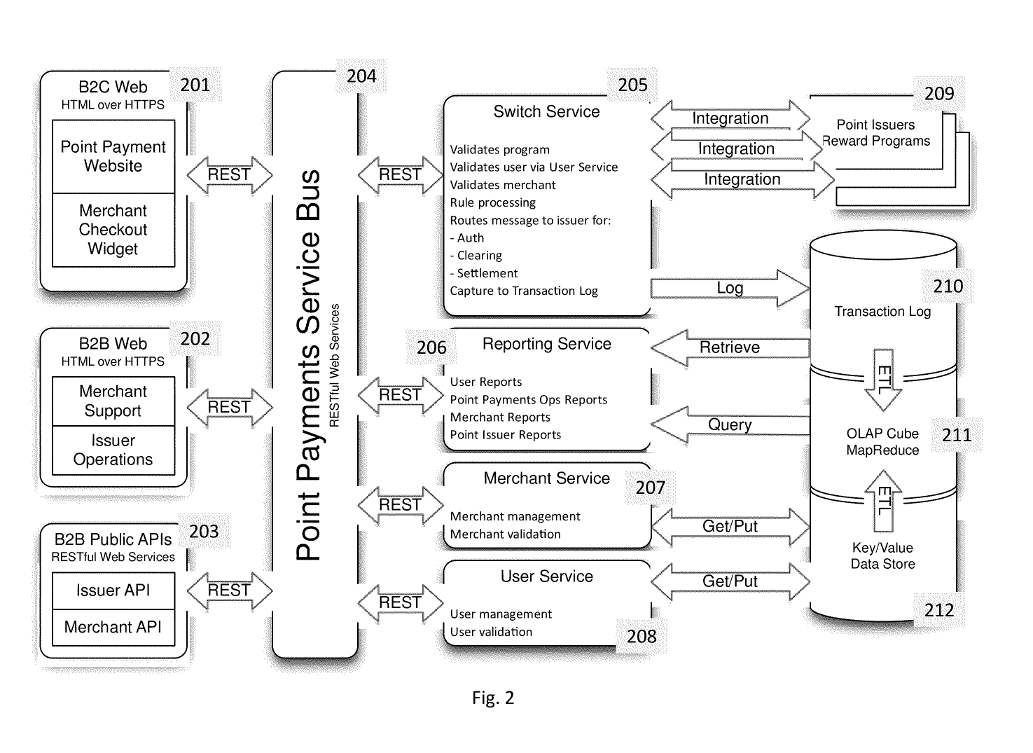

In summary of FIG. 2, the merchant Web site 201 includes a HTML5 hyperlink associated with REST API integrated to the payment processor via a REST API Service Bus 204. When the consumer clicks on the hyperlink, the payment processor determines which currency issuer is relevant to the transaction and serves a SSL-secured or TLS-secured iFrame over the merchant checkout page 201, the iFrame being branded to the relevant currency issuer. In the case that the relevant issuer is unknown, the iFrame includes a list of at least one currency issuer relevant to the merchant from which the user selects their preferred payment source. The user enters their currency issuer account login credentials to the secure iFrame which passes that data via REST API connectivity using AES-256 encryption or, alternatively, via secured OAuth protocol. Once logged in to the currency account, the Switch Service 205 queries the currency account for balance and concurrently converts the transaction amount from the original transaction currency to the virtual currency using a currency conversion rate found via database lookup at the payment processor. The Switch Service 205 of the payment processor applies the conversion rate to determine the virtual currency cost to the consumer and presents that information to the consumer via the iFrame. The consumer clicks on a button on the iFrame to approve the debit to their virtual currency program and the User Service 208 registers that approval in Key/Value Data Store 212 and the Switch Service 205 sends via secure REST API a debit request to the currency issuer 209. The currency issuer 209 processes the debit and sends back via the system's secure integration connection the debit confirmation message, which the system registers in the Transaction Log 210. The Switch Service 205 sends a transaction authorization message via the code of the secure iFrame, hidden from the consumer, and pushed into the relevant data input fields of the merchant site 201. The system generates a currency debit confirmation message sent to the consumer via email. The Reporting Service 206 pulls data stored and organized in the OLAP Cube/MapReduce 211 and generates User Reports published to the Web site associated with the payment processor 201 and publishes Merchant Reports and Issuer Reports to the B2B Web 202. Merchant Service 207 creates merchant accounts, manages merchant accounts and validates merchants during the transaction and servicing processes. User Service 208 creates user accounts, manages user accounts and validates users during the transaction and servicing processes. B2B Public APIs 203 integrate to the Payment Processor Service Bus 204 via REST API and manages the APIs for points issuers and merchants.

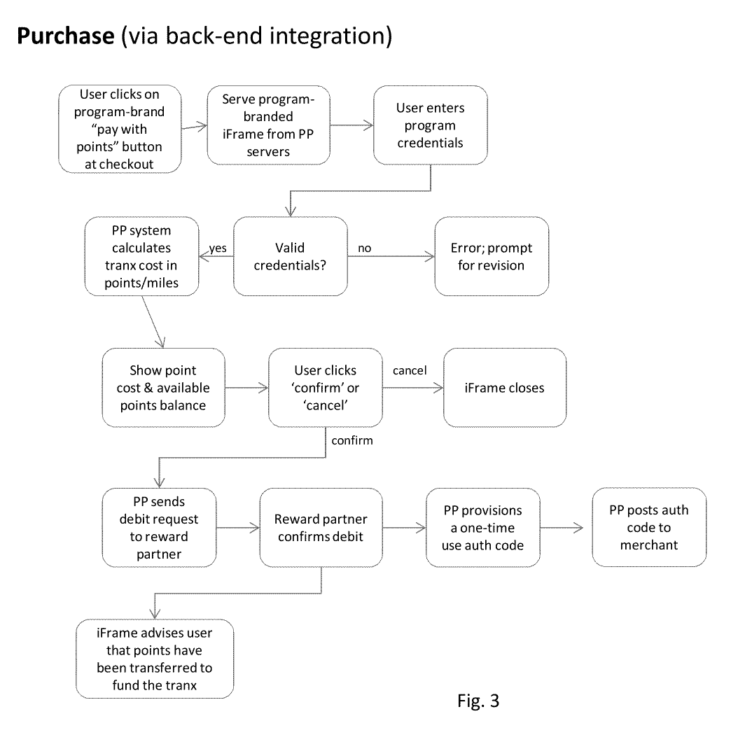

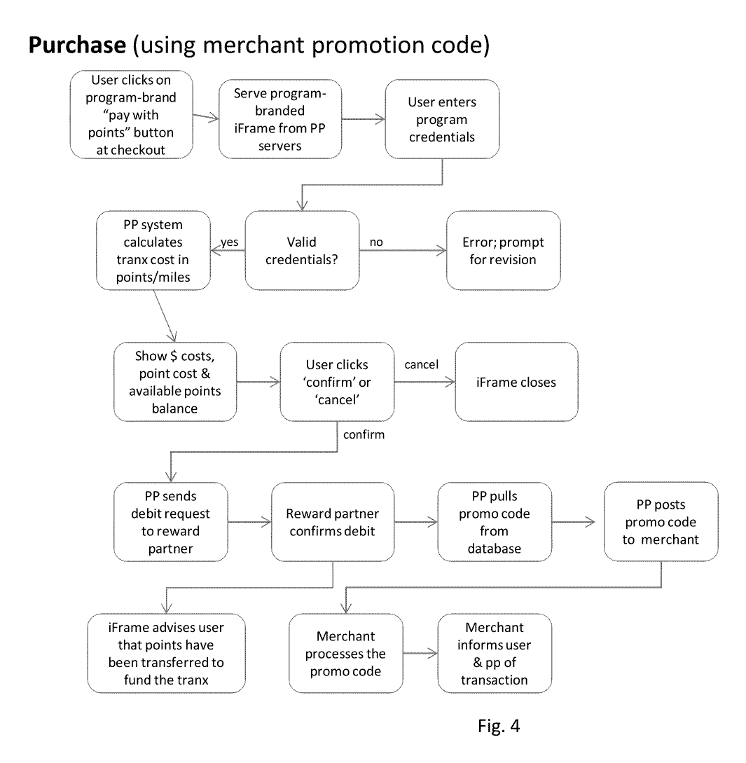

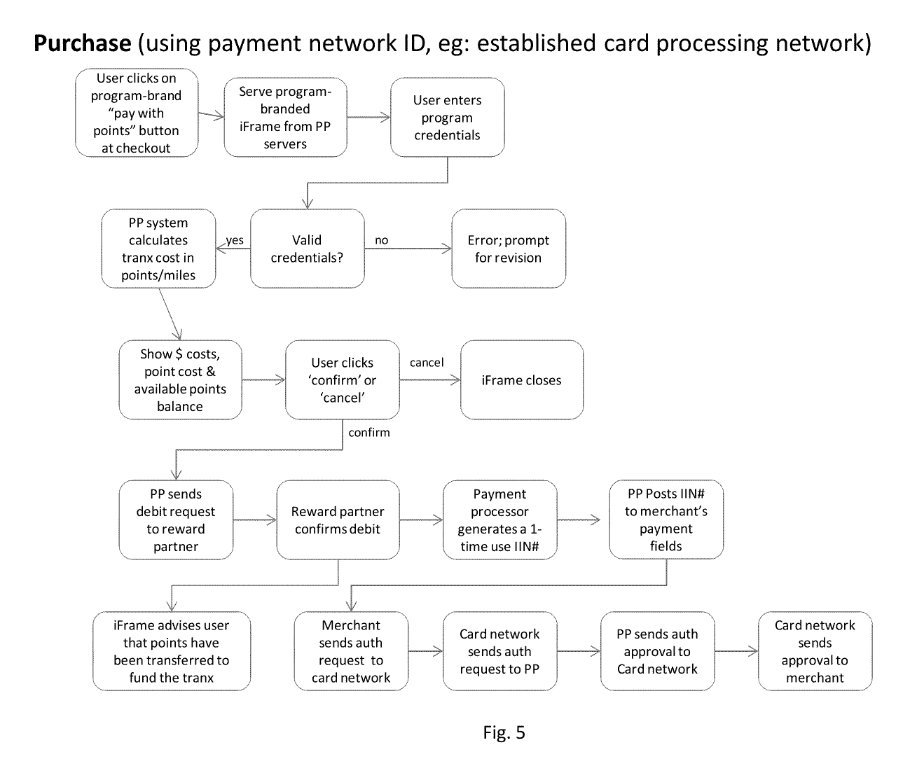

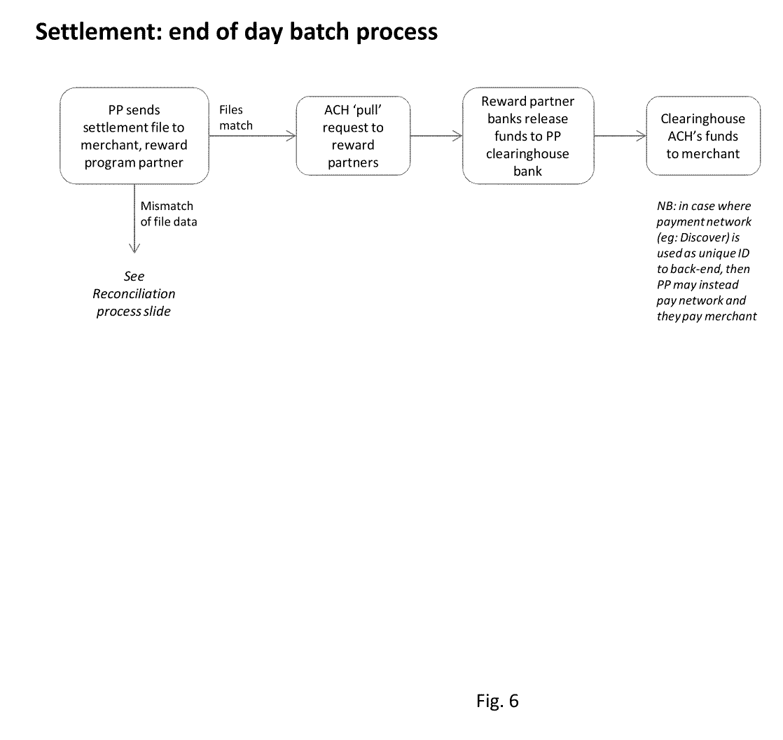

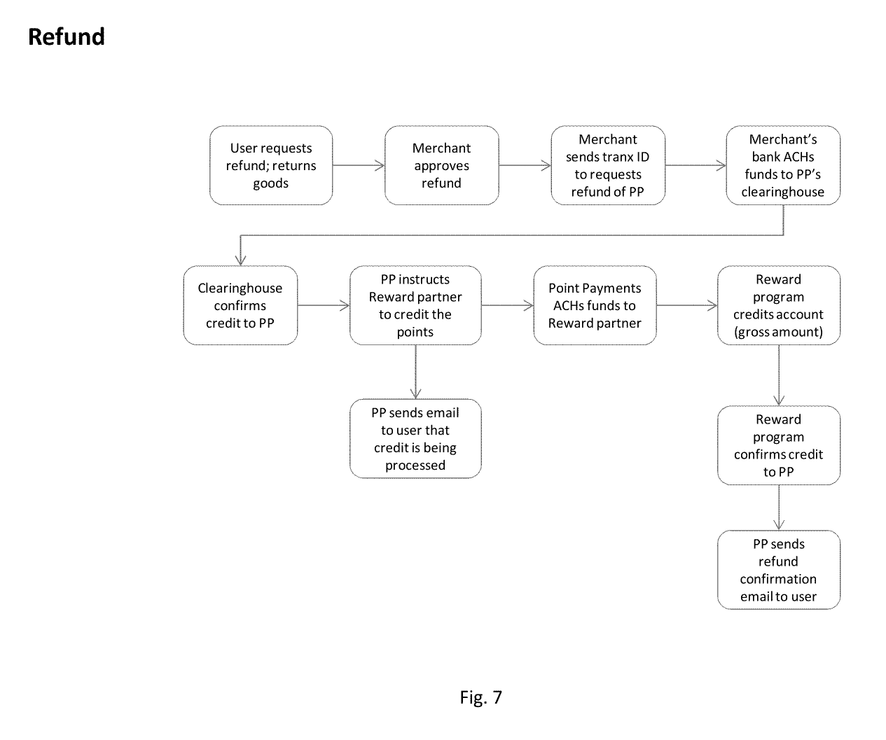

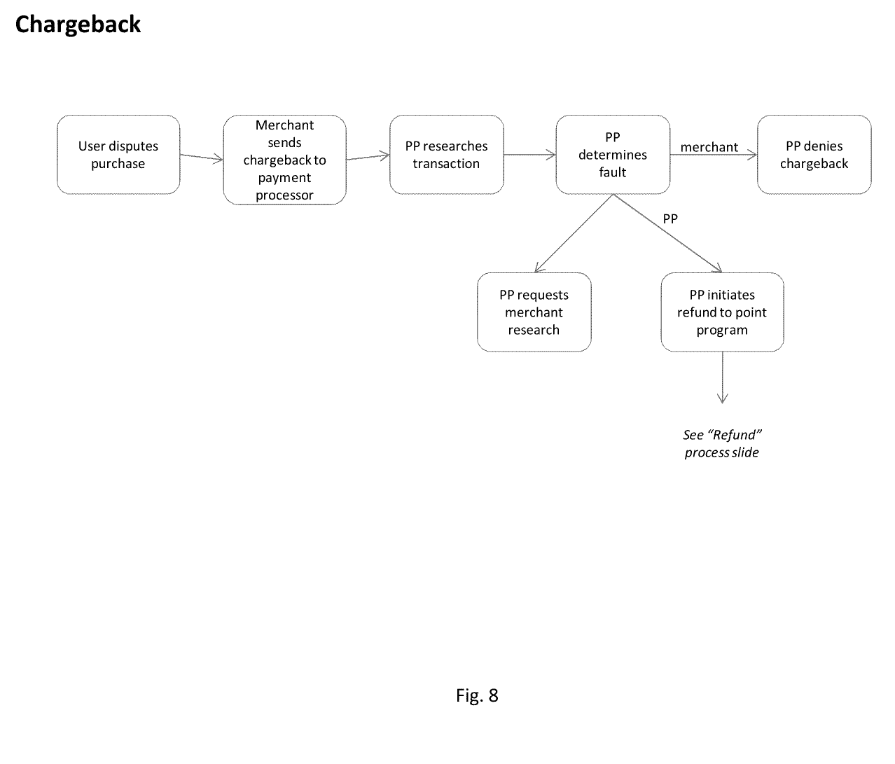

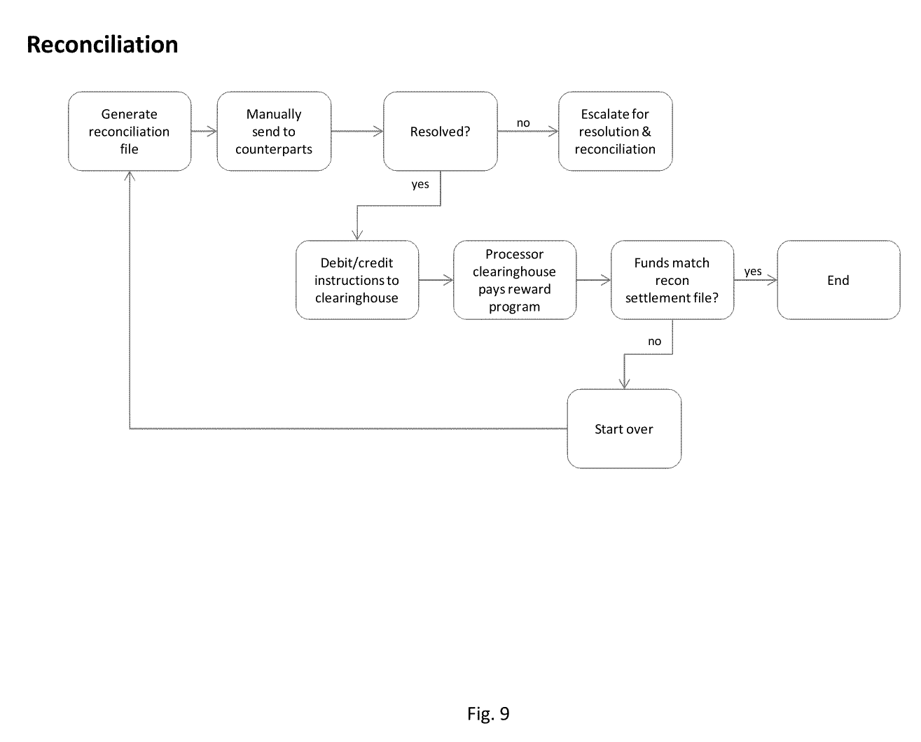

Further description of the common steps of at least one embodiment of the method is provided in the Drawings. FIG. 3 describes the steps of a purchase process of an embodiment with payment processor integrated to the merchant as an established form of payment. FIG. 4 describes the steps of a purchase process of an embodiment with payment processor using a processing code provided by the merchant. FIG. 5 describes the steps of a purchase process of an embodiment with payment processor using a unique identifier code provided by an established payment network such as VISA or Discover. FIG. 6 describes the steps of a settlement process of an embodiment. FIG. 7 describes the steps of a refund process of an embodiment. FIG. 8 describes the steps of a chargeback process of an embodiment. FIG. 9 describes the steps of a reconciliation process of an embodiment.

What is claimed is:

1. The apparatus, system and method to conduct an ecommerce purchase between a merchant and a consumer using virtual currency available to the consumer from a single (unaggregated) virtual currency issuer, the method comprising: serving an iFrame or popup on the merchant site's during the checkout process, capturing user login credentials in that iFrame or popup, sharing the transaction amount from the merchant to the payment processor, validating the consumer with the appropriate virtual currency issuer by effecting a login to the virtual currency system by proxy, validating the merchant and validating the merchant-currency issuer business relationship, determining via look-up to a database or databases a plurality of currency conversion rates for the transaction, specifically at least one conversion rate between the consumer and the currency issuer and at least one conversion rate between the currency issuer and the payment processor, and at least one conversion rate between the payment processor and the merchant, determining a points redemption amount and a real-money currency settlement amount, processing a balance inquiry request of the currency issuer and determining the amount of virtual currency available to the consumer and, by checking a database, the amount, if any, usable at the specific merchant, showing the consumer their transaction cost in virtual currency via the iFrame, soliciting, via the iFrame, and processing the consumer's authorization to debit their virtual currency account, sending a debit request to the currency issuer, the currency issuer receiving such debit request, processing the debit and sending a debit confirmation to the payment processor, the payment processor using the hidden code of the iFrame to send a transaction authorization to the merchant, the merchant accepting that authorization into their system capable of acting on that authorization, sending a transaction confirmation from the merchant to the payment processor, sending a transaction confirmation from the payment processor to the currency issuer, sending a transaction confirmation from the payment processor to the consumer.

2. The method of claim 1, wherein the messaging between merchant and payment processor is routed via a payment gateway

3. The method of claim 1, wherein the user login to the virtual currency provider is executed via OAuth protocols.

4. The method of claim 1, wherein the currency conversion rates employed during the process is determined by the payment processor.

5. The method of claim 1, wherein the authorization provided to the merchant is not a shadow transaction account

6. The method of claim 5, wherein the authorization is unique to the payment processor

7. The method of claim 5, wherein the authorization is unique to the virtual currency issuer

8. The method of claim 5, wherein the authorization is a single-use identification code that interacts with an established payment network

9. The method of claim 1, wherein the process is for a refund and a credit to the currency (rather than a purchase and a debit).

10. The method of claim 1, wherein the process is for a cancellation of the transaction and the credit to the currency account.

11. The method of claim 1, further comprising the currency issuer providing an authorization and holding the debit as pending, and the merchant sending a transaction fulfillment message to the payment processor, the payment processor sending a release instruction to the currency issuer, the currency issuer finalizing the debit.

12. The method of claim 11, wherein the merchant does not send a transaction fulfillment message to the payment processor by a predetermined time and the payment processor instructs the currency issuer to cancel the pending debit.

13. The method of claim 11, wherein the merchant sends a cancellation message to the payment processor, the payment processor sends a cancellation message to the currency issuer and the currency issuer cancels the pending debit.

14. The method of claim 1, further comprising determining other currency issuers acceptable to both merchant and consumer, determining which consumer currency issuer accounts have sufficient balance and, sending alternative options to consumer via the iFrame or popup ad, in a sequential order, one at a time

15. The method of claim 14, wherein the order of alternatives shown to the consumer is random

16. The method of claim 14, wherein the order of alternatives is based on the amount or value of virtually currency available in the consumer's account

17. The method of claim 14, wherein the order of alternatives is driven by consumer preference as indicated by the user in a profile they set up with the system

18. The method of claim 14, wherein the alternatives are shown concurrently in a list, rather than sequentially, that list being served in the iFrame and not as a drop-down or list on the merchant site itself.
